(19) United States
(12) Patent Application Publication
(10) Pub. No.: US 2014/0112127 A1
(43) Pub. Date: Apr. 24, 2014

(54) METHOD AND APPARATUS FOR UPLINK CHANNEL CAPACITY ESTIMATION AND TRANSMISSION CONTROL

(71) Applicants: Venkata Ramanan Venkatachalam Jayaram, San Diego, CA (US); Rohit Kapoor, San Diego, CA (US); Rashid Ahmed Akbar Attar, San Diego, CA (US)

(72) Inventors: Venkata Ramanan Venkatachalam Jayaram, San Diego, CA (US); Rohit Kapoor, San Diego, CA (US); Rashid Ahmed Akbar Attar, San Diego, CA (US)

(73) Assignee: QUALCOMM Incorporated, San Diego, CA (US)

(21) Appl. No.: 13/611,297

(22) Filed: Sep. 12, 2012

Related U.S. Application Data
(60) Provisional application No. 61/592,076, filed on Jan. 30, 2012.

(51) Int. Cl. H04W 24/08; H04W 28/02

(52) U.S. Cl. CPC H04W 24/08; H04W 28/0231
USPC 370/230; 370/252

(57) ABSTRACT

Aspects of the present disclosure relate generally to wireless communication systems, and more particularly, to estimation of an uplink channel capacity. In an aspect, provided is a method of wireless communication, which may include determining whether a current transmit time interval (TTI) is relevant for computing the uplink channel capacity estimate, determining the transmission type of the current TTI where the current TTI is relevant, determining whether data is transmitted during the current TTI, computing a data capacity value based on at least one upload channel parameter, summing the data capacity values of TTIs from a window length start TTI to the current TTI to generate a data capacity sum, computing the uplink channel capacity estimate as a ratio of the data capacity sum to a total time period of all relevant TTIs during a window length interval, and accordingly adjusting a transmission rate of output traffic.

### CLAIM OF PRIORITY UNDER 35 U.S.C. §119

The present Application for Patent claims priority to Provisional Application No. 61/592,076 entitled “METHOD AND APPARATUS FOR UPLINK CHANNEL CAPACITY ESTIMATION AND TRANSMISSION CONTROL” filed Jan. 30, 2012, and assigned to the assignee hereof and hereby expressly incorporated by reference herein.

### BACKGROUND

1. Field

Aspects of the present disclosure relate generally to wireless communication systems, and more particularly, to estimation of capacity of an uplink channel.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

Furthermore, in wireless systems, the capacity of the uplink channel, or the user equipment (UE) transmission channel, may vary over time due to effects such as channel fading and system load variation. In some situations, such as video telephony, these effects can be severely negative. For example, if a UE is unaware of a sudden drop in upload channel capacity, the UE may continue generating uplink data that exceeds the channel capacity. This can in turn lead to greater transmission buffering and corresponding queuing delay, which may cause a degraded user experience. In addition, when upload channel conditions abruptly improve, a UE may continue operating as if the upload channel conditions remain poor. As such, if the UE is unaware of such an improvement, it may squander an opportunity to transmit data at a greater rate. In this scenario, though the user experience is not exceptionally degraded, there exists an opportunity cost as the UE would not utilize the full capacity of the upload channel.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the present disclosure, provided is a method of wireless communication, which may include determining a data capacity associated with a time interval, wherein the data capacity comprises a sum of one or more data capacities of each of at least one relevant transmit time interval (TTI) during the time interval and dividing the data capacity associated with the time interval by a total time occupied by the at least one relevant TTI during the time interval to obtain a data channel estimate. Example methods may also include determining the relevance of a current TTI, determining the transmission type of the current TTI where the current TTI is determined to be relevant, determining whether data is transmitted during the current TTI, computing a data capacity value based on at least one upload channel parameter, summing the data capacity values of TTIs from a window length start TTI to the current TTI to generate a data capacity sum, and adjusting output traffic based upon the data channel estimate.

Furthermore, the disclosure presents an apparatus for wireless communication, which may include means for determining a data capacity associated with a time interval, wherein the data capacity comprises a sum of one or more data capacities of each of at least one relevant transmit time interval during the time interval and dividing the data capacity associated with the time interval by a total time occupied by the at least one relevant TTI during the time interval to obtain a data channel estimate. Example apparatuses may also include means for determining the relevance of a current transmit time interval, means for determining the transmission type of the current TTI where the current TTI is determined to be relevant, means for determining whether data is transmitted during the current TTI, means for computing a data capacity value based on at least one upload channel parameter, means for summing the data capacity values of TTIs from a window length start TTI to the current TTI to generate a data capacity sum, and means for adjusting output traffic based upon the data channel estimate.

In an additional examples provided by the present disclosure, provided is a computer program product, which includes a computer-readable medium, which itself includes code or instructions for performing any or all of determining the relevance of a current transmit time interval, determining the transmission type of the current TTI where the current TTI is determined to be relevant, determining whether data is transmitted during the current TTI, computing a data capacity value based on at least one upload channel parameter, summing the data capacity values of TTIs from a window length start TTI to the current TTI to generate a data capacity sum, computing a ratio of the data capacity sum to a total time period of all relevant TTIs during a window length interval to determine an uplink capacity estimate, adjusting output traffic based upon the ratio.

Further presented herein is an apparatus for wireless communication, which may include at least one processor and a memory coupled to the at least one processor, where the at least one processor is configured to determining a data capacity associated with a time interval, wherein the data capacity comprises a sum of one or more data capacities of each of at least one relevant transmit time interval during the time interval and dividing the data capacity associated with the time interval by a total time occupied by the at least one relevant TTI during the time interval to obtain a data channel estimate. Example functions of such at least one processor may additionally include determining the relevance of a current transmit time interval, determine the transmission type of the current TTI where the current TTI is determined to be relevant, determine whether data is transmitted during the current TTI, computing a data capacity value based on at least one upload channel parameter, sum the data capacity values of TTIs from a window length start TTI to the current TTI to generate a data capacity sum, and adjusting output traffic based upon the data channel estimate.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents. These and other aspects of the invention will become more fully understood upon a review of the detailed description, which follows.

### BRIEF DESCRIPTION OF THE DRAWINGS

FIG. 1 is a block diagram illustrating an example of a hardware implementation for an apparatus employing a processing system.

FIG. 2 is a block diagram conceptually illustrating an example of a telecommunications system.

FIG. 3 is a conceptual diagram illustrating an example of an access network.

FIG. 4 is a conceptual diagram illustrating an example of a radio protocol architecture for the user and control plane.

FIG. 5 is a block diagram conceptually illustrating an example of a Node B in communication with a UE in a telecommunications system.

FIG. 6 is a block diagram illustrating aspects of an example user equipment of the present disclosure.

FIG. 7 is a flow diagram illustrating aspects of an example method contemplated by the present disclosure.

FIG. 8 is block diagram illustrating aspects of an example uplink channel capacity estimating component of the present disclosure.

FIG. 9 is block diagram illustrating an example logical grouping of electrical components of the present disclosure.

FIG. 10 is a graph illustrating a non-limiting example highlighting the computation of Data_capacity in various cases.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure presents methods and apparatuses for estimating a data channel (e.g. an uplink data channel from a user equipment (UE) to a network entity, such as a NodeB) based on the ratio of the sum of the data capacities of “relevant” transmission time intervals (TTIs) in a window period to the time during the window period occupied by the relevant TTIs. In an aspect, the UE may determine whether a given TTI is relevant according to certain configured criteria, which will be presented herein. Based on the data channel estimation, the UE may adjust its uplink transmission characteristics and/or uplink queuing processes in order to tailor the characteristics and processes to current uplink channel conditions, which may provide for optimized queuing delay and a robust user experience.

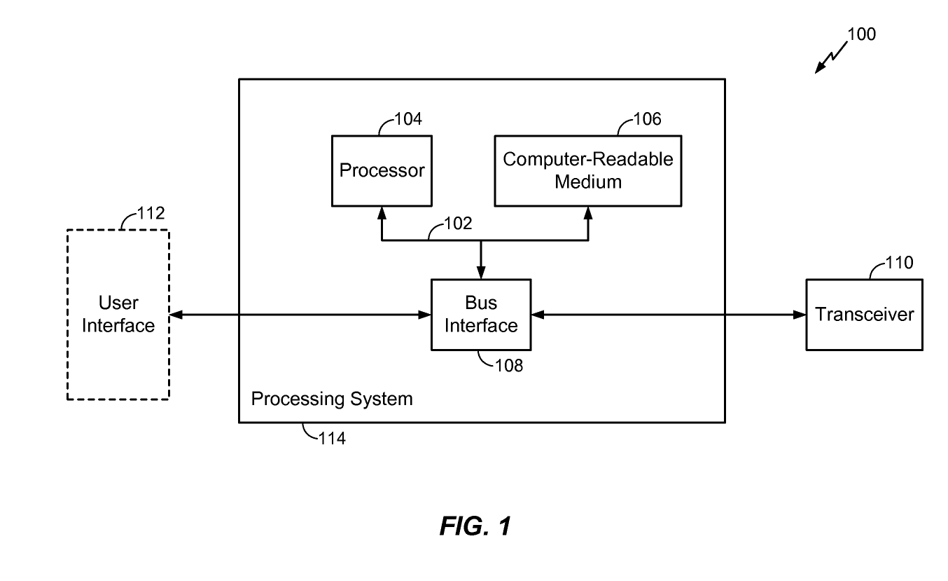

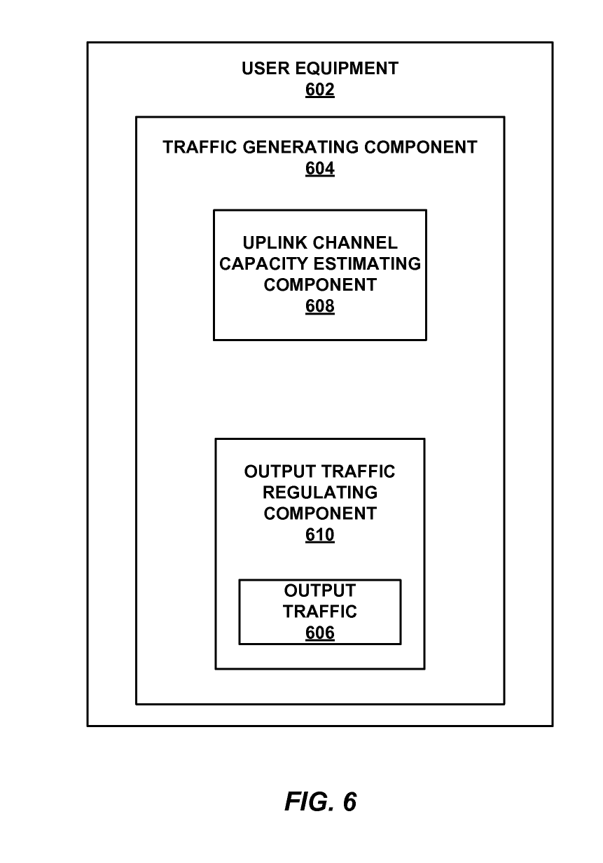

FIG. 1 is a block diagram illustrating an example of a hardware implementation for an apparatus 100 employing a processing system 114. In an aspect, apparatus 100 may be a UE configured to perform channel estimation according to the apparatus and methods presented herein, see, e.g., FIGS. 6-10 and the corresponding description. In some examples, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

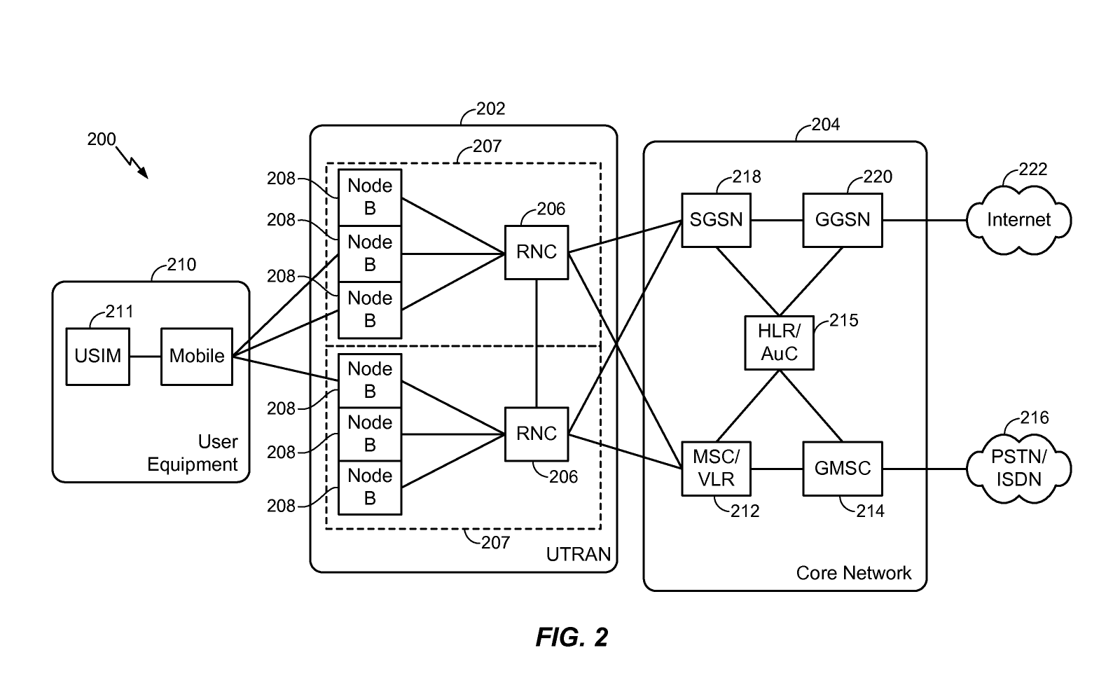

The various concepts presented throughout this disclosure may be implemented across a broad variety of telecommunication systems, network architectures, and communication standards. By way of example and without limitation, the aspects of the present disclosure illustrated in FIG. 2 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. In an aspect, UE 210 may be a UE configured to perform channel estimation according to the apparatus and methods presented herein, see, e.g., FIGS. 6-10 and the corresponding description. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information herein below utilizes terminology introduced in the RRC Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the uplink (UL), also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI. “HSPA Evolved” or HSPA+ is an evolution of the HSPA standard that includes MIMO and 64-QAM, enabling increased throughput and higher performance That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another. On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

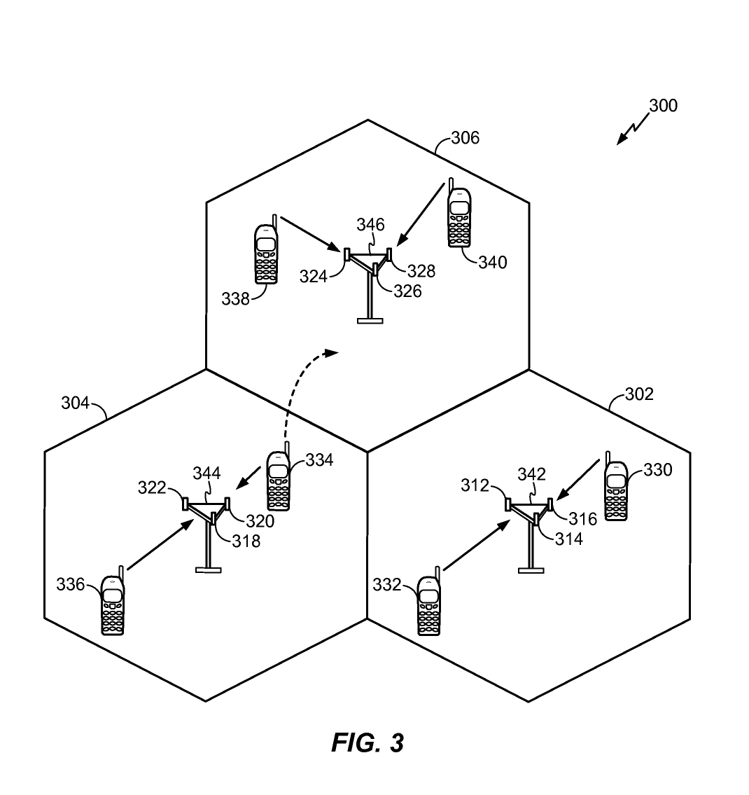

Referring to FIG. 3, an access network 300 in a UTRAN architecture is illustrated. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 2) for all the UEs 330, 332, 334, 336, 338, 340 in the respective cells 302, 304, and 306. In an aspect, one or more of UEs 330, 332, 334, 336, 338, 340 may be a UE configured to perform channel estimation according to the apparatus and methods presented herein, see, e.g., FIGS. 6-10 and the corresponding description.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 2), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

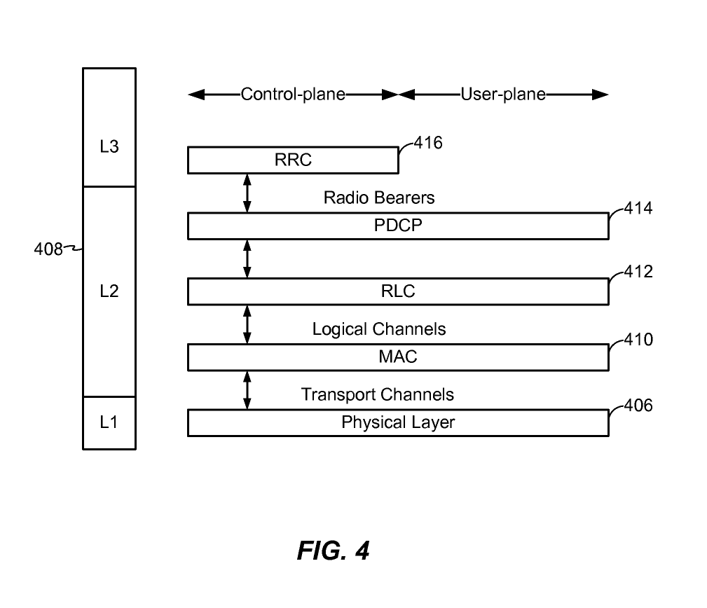

The radio protocol architecture may take on various forms depending on the particular application. An example for an HSPA system will now be presented with reference to FIG. 4. FIG. 4 is a conceptual diagram illustrating an example of the radio protocol architecture for the user and control planes.

Turning to FIG. 4, the radio protocol architecture for the UE and node B is shown with three layers: Layer 1, Layer 2, and Layer 3. Layer 1 is the lowest lower and implements various physical layer signal processing functions. Layer 1 will be referred to herein as the physical layer 406. Layer 2 (L2 layer) 408 is above the physical layer 406 and is responsible for the link between the UE and node B over the physical layer 406.

In the user plane, the L2 layer 408 includes a media access control (MAC) sublayer 410, a radio link control (RLC) sublayer 412, and a packet data convergence protocol (PDCP) 414 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between node Bs. The RLC sublayer 412 provides segmentation and reassembly of upper layer data packets, retransmission of lost data packets, and reordering of data packets to compensate for out-of-order reception due to hybrid automatic repeat request (HARQ). The MAC sublayer 410 provides multiplexing between logical and transport channels. The MAC sublayer 410 is also responsible for allocating the various radio resources (e.g., resource blocks) in one cell among the UEs. The MAC sublayer 410 is also responsible for HARQ operations.

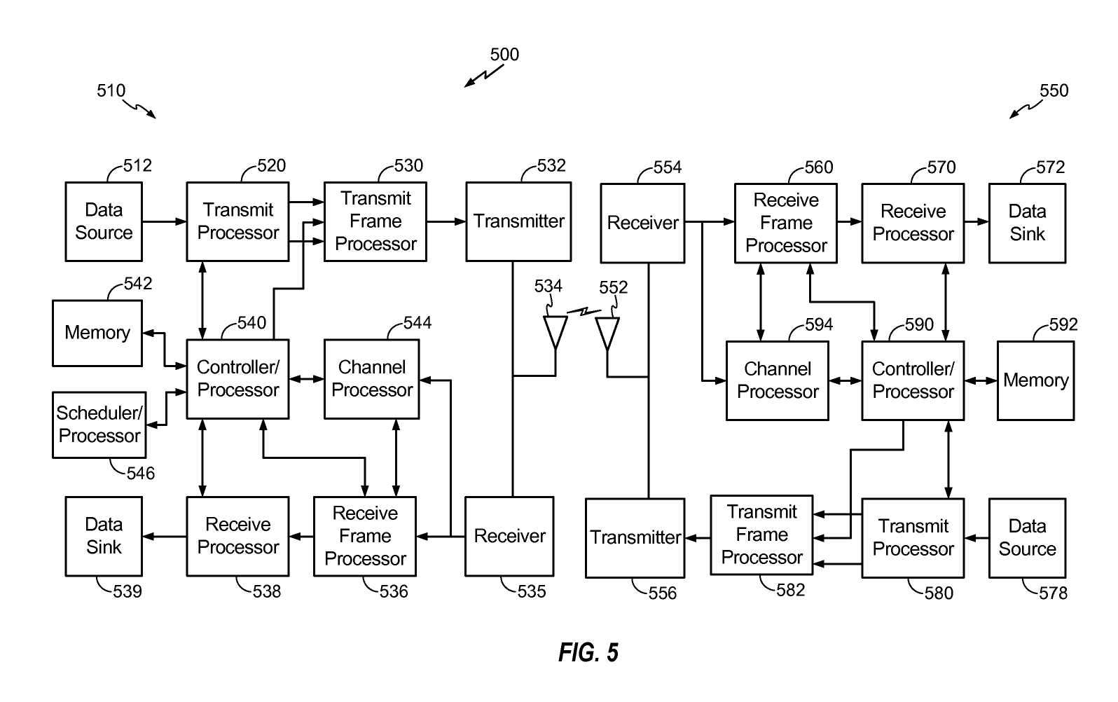

FIG. 5 is a block diagram of a Node B 510 in communication with a UE 550, where the Node B 510 may be the Node B 208 in FIG. 2, and the UE 550 may be the UE 210 in FIG. 2. Moreover, in an aspect, UE 550 may be a UE configured to perform channel estimation according to the apparatus and methods presented herein, see, e.g., FIGS. 6-10 and the corresponding description. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

Turning to FIG. 6, in aspects of the present disclosure, a user equipment (UE) 602 may include a traffic generating component 604 for producing output traffic 606. In an aspect, output traffic 606 is transmitted by the UE over a wireless uplink channel to network devices (not shown), such as, but not limited to, one or more base stations or NodeBs. Additionally, traffic generating component 604 may include an uplink channel capacity estimating component 608, which may estimate an uplink channel capacity, and an output traffic regulating component 610 for adjusting output traffic 606 for transmission based on the estimated uplink channel capacity.

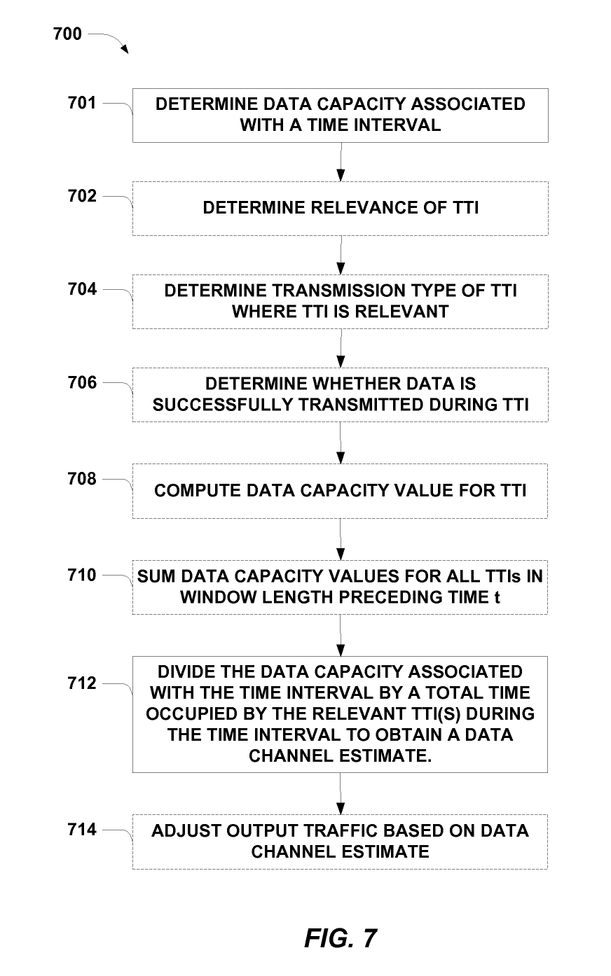

Turning to FIG. 7, a method 700 is provided for estimating the capacity of an uplink channel. For example, this can include summing the data capacities of individual transfer time intervals (TTI) over a period of time that corresponds to a transmit window length. In a further aspect, an uplink channel capacity estimation is computed at a given time t by applying an algorithm over a time period T immediately preceding t. In an example, T is equal to the length of a predetermined window length parameter L, which may correspond to a transmission window length for the UE. In other words, in an aspect, T=(t−L, t). In an aspect, the uplink channel capacity estimating component 608 may use the equation below to estimate the uplink channel at time t, the following formula may be applied for the period T:

$$UL Channel Capacity Estimate ( t ) = \frac{{\sum }_{Relevant TTIs in T} TTI Data Capacity}{Total Time Occupied by Relevant TTIs}$$

Therefore, as represented by the above equation, in an aspect of the present disclosure, an uplink channel capacity estimation at t can be realized by summing the TTI data capacities at all relevant TTIs over T and dividing that sum by the total amount of time occupied by the relevant TTIs.

In an aspect, uplink channel capacity estimating component 608 (FIG. 6) may determine the data capacity associated with a time interval at block 701. In doing so, the uplink channel capacity estimating component 608 or components therein may optionally determine the relevance of a transmit time interval (TTI) at block 702. In an aspect, uplink channel capacity estimating component 608 can generally determine a TTI as relevant where there exists data awaiting transmission during the TTI or data is transmitted or retransmitted during the TTI. There can be one or more TTI relevance exceptions, however, in some aspects. For example, when a transmission buffer in the UE 600 (e.g. output traffic 606) is empty and a serving grant provided by the network is zero, the arrival of data to the transmission buffer triggers scheduling information (SI) to be sent to the uplink. The SI is used to inform the network the UE 600 has data to transmit and needs a serving grant from the network to commence transmission of the data. In a first exception from being a relevant TTI (e.g., a first TTI relevance exception), if the TTI amounts to time taken for the SI to be acknowledged by the network, uplink channel capacity estimating component 608 can determine the TTI as not a relevant TTI. In a second TTI relevance exception, uplink channel capacity estimating component 608 can also determine TTIs corresponding to a hybrid automatic repeat request (HARQ) process that is currently undergoing retransmission as not relevant TTIs. In an aspect, where the TTI is considered not relevant, uplink channel capacity estimating component 608 can ignore the TTI in computing the uplink channel capacity.

In another aspect, where the TTI is relevant, the uplink channel capacity estimating component 608 may determine a transmission type for the TTI at block 704. By non-limiting example, a transmission type may be a first transmission attempt of a signal or data packet (such as in a HARQ process), a retransmission attempt (again, which may be a HARQ process), or no transmission at all occurred during the particular TTI. In the case of no transmission attempt occurring during the TTI, the uplink channel capacity estimating component 608 may determine that the data capacity parameter for the TTI equals zero. Furthermore, at block 706, where transmission was attempted at block 704 in a TTI, the uplink channel capacity estimating component 608 may determine whether the data was successfully transmitted during the TTI (e.g., based on whether the UE receives an acknowledgment signal (ACK) or a non-acknowledgment signal (NACK) from the network for the data).

Based on the transmission type ascertained at block 704 and whether the transmission was successful at block 706, the uplink channel capacity estimating component 608 may compute a value for the TTI Data Capacity value used to calculate the UL Channel Capacity Estimate at block 708. Consider the following non-limiting exemplary scenarios and their corresponding relevant TTI Data Capacity values that uplink channel capacity estimating component 608 may compute at block 706 for a TTI at t. First, where there was no transmission in the current TTI (block 704), the TTI Data Capacity may equal zero.

Next, in the case where the UE made its first transmission attempt in the current TTI (block 704), the TTI Data Capacity value may depend on whether the UE successfully transmitted data (e.g. the transmitted data prompts a corresponding acknowledgement message (ACK) to be generated at a receiving device, such as a NodeB, radio network controller, or other network entity, and transmitted to the UE). For example, in an aspect, where the UE transmits data correctly (e.g. the UE receives an ACK) (block 706) the TTI Data Capacity may be represented as:

$$TTI Data Capacity = \frac{min ( MaxDataPerGrant , MaxDataPerHeadroom )}{1 + Number of Retransmissions}$$

where MaxDataPerGrant is a maximum amount of data that could have been transmitted in the TTI as governed by the serving grant from the network in that TTI, MaxDataPerHeadroom is a maximum amount of data that could have been transmitted in the TTI as governed by the headroom limit, and the Number of Retransmissions is the number of retransmissions the UE went through before successfully completing the transmission.

In an alternative aspect, where the UE fails to transmit data that is successfully received (e.g. the UE receives a NACK or reaches a maximum number or retransmissions) (block 706), the TTI Data Capacity may be set to zero.

In an additional scenario, the UE may be carrying out retransmission in the current TTI (from block 704). In such a scenario, where the retransmission is successful (e.g. the UE receives an ACK) (block 706), the TTI Data Capacity may be represented as:

$$TTI Data Cap . = \frac{max ( DataBeingRetx , min ( \begin{matrix}MaxDataPerHeadroom , \\ MaxDataPerGrant\end{matrix} ) )}{1 + Number of Retransmissions}$$

where DataBeingRetransmitted is the amount of data that is being retransmitted in the TTI, the MaxDataPerGrant is the maximum amount of data that could have been transmitted in the TTI as governed by the serving grant from the network in that TTI, the MaxDataPerHeadroom is the maximum amount of data that could have been transmitted in the TTI as governed by the headroom limit in that TTI, and the Number of Retransmissions is the number of retransmissions the UE went through before successfully completing the transmission.

In an alternative aspect, where the UE fails to retransmit data (e.g. where the UE receives a NACK or reaches a maximum number or retransmissions) (block 706), the UE can set the TTI Data Capacity Value to zero.

After the TTI Data Capacity parameter value is computed for the current TTI of time t according to the above criteria, at block 710, the uplink channel capacity estimating component 608 may sum the TTI Data Capacity values of all relevant TTIs over a preceding period L, which may correspond to a window length, such as, but not limited to, a UE transmission window length. The result of this summation may serve as the

$${\sum }_{Relevant TTIs in T} TTI Data Capacity$$

term in for determining the UL Channel Capacity Estimate (t).

Furthermore, at block 712, the uplink channel capacity estimating component 608 may divide the data capacity associated with the time interval (the result of the individual TTI Data Capacity summation) by the time occupied by the relevant TTIs in the time interval to compute a resulting data capacity estimate associated with a data channel. This ratio may be final value of the UL Channel Capacity Estimate and may serve as the uplink channel capacity estimation value. Additionally, at block 714, the UE and/or the output traffic regulating component 610 may adjust output traffic 606 based upon this calculated uplink channel capacity estimate value. For example, output traffic regulating component 610 can determine an amount of data to communicate over the uplink channel based on the estimated uplink channel capacity. In one example, the output traffic regulating component 610 can use the uplink channel capacity estimate (e.g., in conjunction with a traffic generating application) to adapt transmission rate of the UE 600. This can help in avoiding excessive queuing delays, avoiding overloading of the uplink channel, etc.

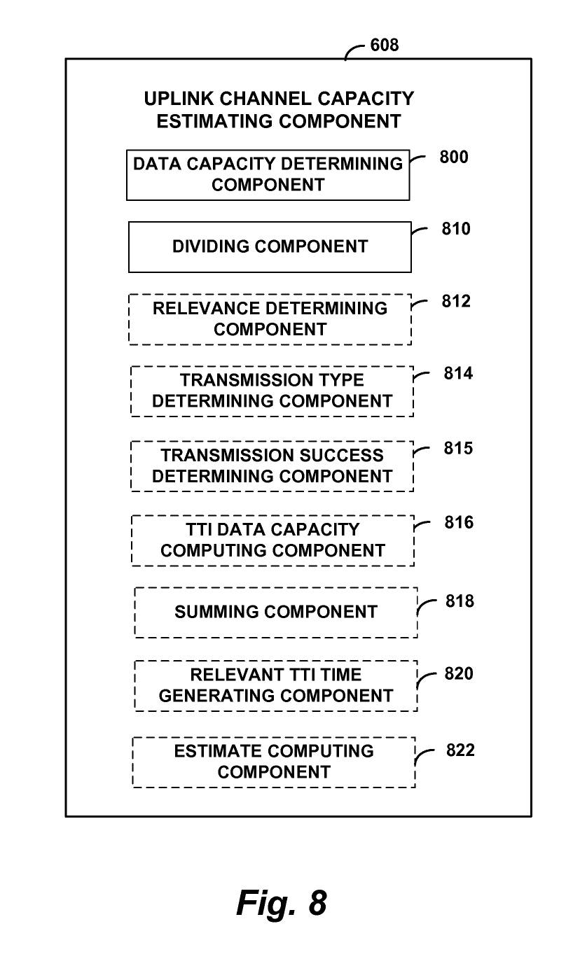

In one aspect, uplink channel capacity estimating component 608 (FIG. 6) may be represented by the diagram of FIG. 8. In an aspect, the uplink channel capacity estimating component 608 may include a data capacity determining component, which may be configured to determine a data capacity associated with one or more TTIs. Furthermore, the uplink channel capacity estimating component 608 may include a dividing component 810, which may be configured to divide a data capacity estimate by a total time occupied by relevant TTIs during a time interval, such as a transmission window.

In an optional and additional aspect, uplink channel capacity estimating component 608 may include a relevance determining component 812, which may be configured to determine whether a transmit time interval (TTI) is relevant, such as a current TTI, as described above. Additionally, uplink channel capacity estimating component 608 may include a transmission type determining component 814, which may be configured to determine the transmission type of a TTI where the relevance determining component 812 determines that the TTI is relevant. By non-limiting example, a transmission type may be a first transmission attempt of a signal or data packet (such as in a HARQ process), a retransmission attempt (again, which may be a HARQ process), or no transmission at all occurred during the particular TTI. In addition, uplink channel capacity estimating component 608 may include a transmission success determining component 815, which may determine if a transmission during a particular TTI was successful. In an aspect, transmission success determining component 815 may ascertain whether such a transmission was successful by receiving an ACK or NACK for the transmission from the network.

Furthermore, uplink channel capacity estimating component 608 may include a TTI Data Capacity computing component 816, which may be configured to compute a TTI Data Capacity term according to the outputs of the relevance determining component 812, the transmission type component 814, and the transmission success determining component 815. Based on these outputs, the TTI Data Capacity computing component 816 may compute TTI Data Capacity of a TTI, such as, but not limited to, a current TTI. In an aspect, the TTI Data Capacity computing component 816 may be configured to compute the minimum or maximum of two or more stored uplink channel parameters that are associated with the uplink channel or traffic. In some aspects, these uplink channel parameters may include, but are not limited to MaxDataPerGrant, MaxDataPerHeadroom, Number of Retransmissions, DataBeingRetransmitted (DataBeingRetx), as defined above. In a further aspect, these parameters may be stored in a memory on UE 602, which may be located in any component thereon, including in TTI Data Capacity computing component 816, and can be similar to a memory 542 or 592 in FIG. 5. In addition, the TTI Data Capacity computing component 816 may be configured to perform mathematical operations using these parameters to compute a TTI Data Capacity value for current TTI.

In addition, uplink channel capacity estimating component 608 may include a summing component 818, which may be configured to sum the TTI Data Capacity values of the TTIs of time period immediately preceding a current time t, where the previous time period may have a length equal to a window length of a UE transmission window. This resulting sum may be the numerator value for the equation defining UL Channel Capacity Estimate (t), above—namely,

$${\sum }_{Relevant TTIs in T} TTI Data Capacity ,$$

which may be output to one or more other components in UE 602 or external devices. Additionally, uplink channel capacity estimating component 608 may include a relevant TTI time generating component 820, which may store and/or compute a value of the total time occupied by relevant TTIs in a time period immediately preceding a current time t, where the previous time period may have a length equal to a window length of a UE transmission window. This total time occupied by relevant TTIs value may serve as the denominator parameter for the equation defining UL Channel Capacity Estimate (t), above.

Furthermore, uplink channel capacity estimating component 608 may include a estimate computing component 822, which may be configured to compute a ratio of the data capacity sum (e.g., from summing component 818) to the total time occupied by relevant TTIs (e.g., from relevant TTI time generating component 820). In an aspect, this ratio may serve as an uplink channel capacity estimate for time t. Furthermore, in an aspect, uplink channel capacity estimating component 608 may send the uplink channel capacity estimate for time t to output traffic regulating component 610 (FIG. 6), which may adjust output traffic 606 based on the uplink channel capacity estimate, as described.

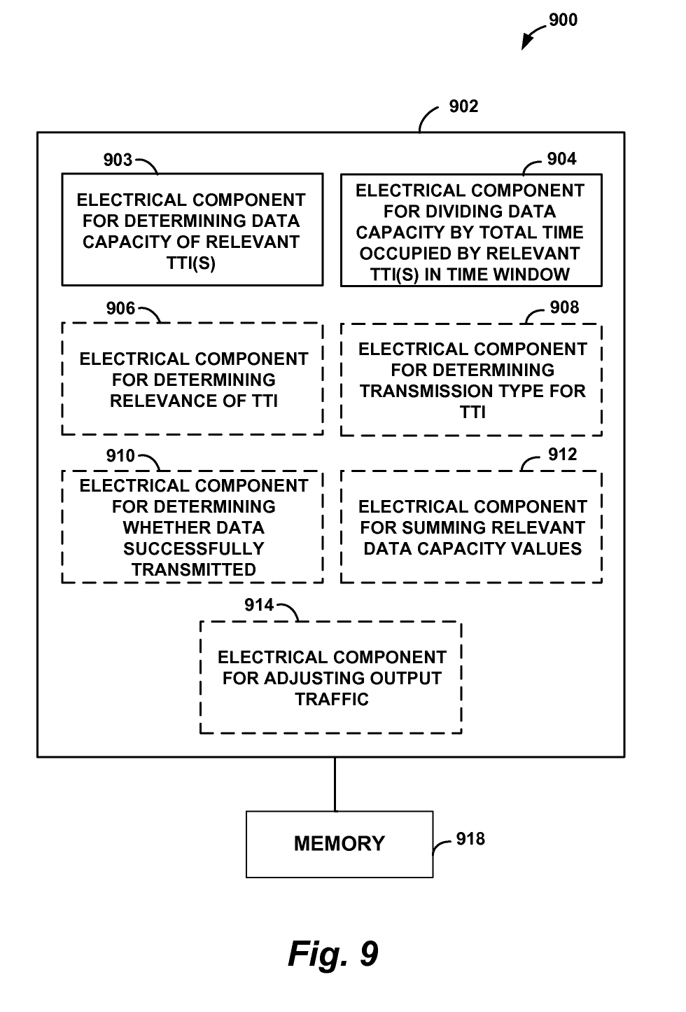

Referring to FIG. 9, an example system 900 is displayed for adjusting output traffic from a UE based on an uplink channel capacity estimate. For example, system 900 can reside at least partially within a device. It is to be appreciated that system 900 is represented as including functional blocks, which can be functional blocks that represent functions implemented by a processor, software, or combination thereof (e.g., firmware). System 900 includes a logical grouping 902 of electrical components that can act in conjunction.

For example, logical grouping 902 can include an electrical component 903 for determining data capacity of relevant TTIs. In an aspect, electrical component 903 may be data capacity determining component 800 (FIG. 8). Furthermore, logical grouping 902 may include electrical component 904 for dividing data capacity by total time occupied by relevant TTIs in a time window. In an aspect, electrical component 904 may be dividing component 810 (FIG. 8). Additionally, logical grouping 902 may include electrical component 906 for determining the relevance of a TTI. In an aspect, electrical component 906 may be relevance determining component 812 (FIG. 8), and may be configured to determine the relevance of a particular TTI based upon criteria outlined above. In addition, logical grouping 902 may include an electrical component 908 for determining the transmission type for a TTI. In an aspect, electrical component 908 may be transmission type determining component 814 (FIG. 8), and the transmission type determined may be a first transmission attempt of a signal or data packet (such as in a HARQ process), a retransmission attempt (again, which may be a HARQ process), or no transmission at all occurred during the particular TTI. Furthermore, logical grouping 902 may include an electrical component 910 for determining whether data was successfully transmitted during a particular TTI. In an aspect, electrical component 910 may be transmission success determining component 815 (FIG. 8), and may be configured to determine if the UE received an ACK or NACK related to a transmission during the particular TTI.

Furthermore, logical grouping 902 may include an electrical component 912 for summing relevant data capacity values. In an aspect, electrical component 912 may be summing component 818 (FIG. 8). In an additional aspect, logical grouping 902 may include an electrical component 914 for adjusting output traffic. In an aspect, electrical component 916 may be output traffic regulating component 610, and may be configured to allow transmission of more or less data on the uplink depending on an uplink channel capacity estimate from electrical component 914.

Additionally, system 900 can include a memory 918 that retains instructions for executing functions associated with the electrical components 903, 904, 906, 908, 910, 912, and 914, stores data used or obtained by the electrical 903, 904, 906, 908, 910, 912, and 914, etc. While shown as being external to memory 918, it is to be understood that one or more of the electrical components 903, 904, 906, 908, 910, 912, and 914 can exist within memory 918. In one example, electrical components 903, 904, 906, 908, 910, 912, and 914 can comprise at least one processor, or each electrical component 903, 904, 906, 908, 910, 912, and 914 can be a corresponding module of at least one processor. Moreover, in an additional or alternative example, electrical components 903, 904, 906, 908, 910, 912, and 914 can be a computer program product including a computer readable medium, where each electrical component 903, 904, 906, 908, 910, 912, and 914 can be corresponding code.

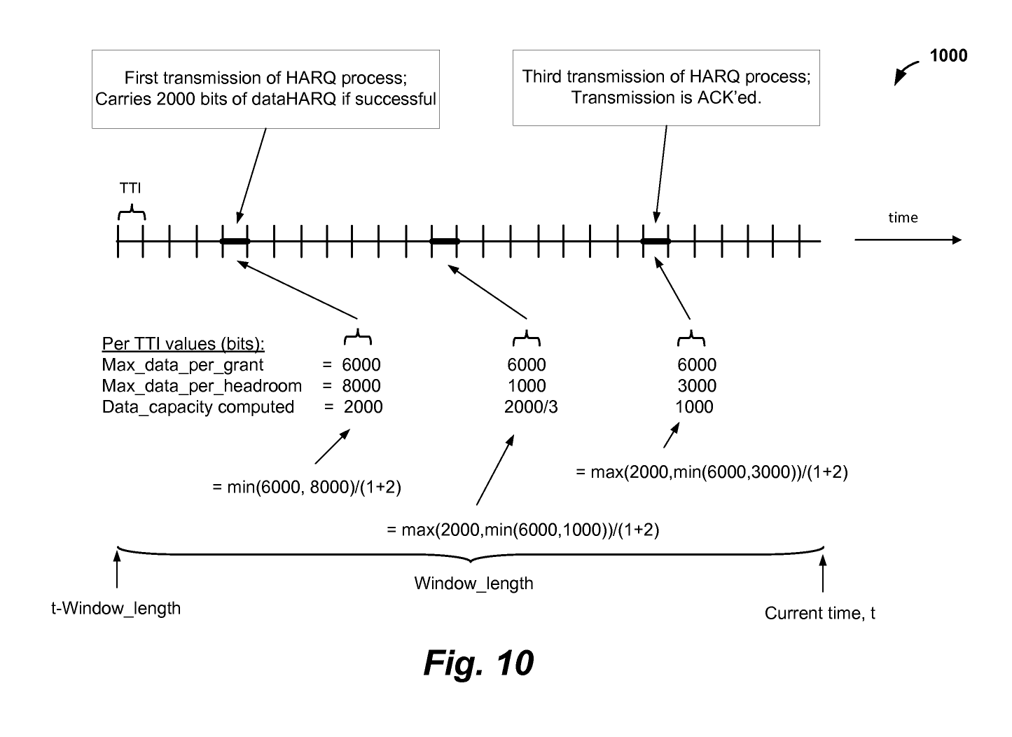

Referring to FIG. 10, in one example of a use case that should not be construed as limiting, a graph 1000 illustrates how the Data_capacity of a relevant TTI may be computed. The formula for computing Data_capacity depends on certain conditions, as discussed herein, and FIG. 10 illustrates a non-limiting example highlighting different cases that arise.

It should be noted that in each relevant TTI, either of the following may happen with regard to the HARQ process:
1) There was no transmission in this TTI: thus, Data_capacity of the TTI is taken to be 0.
2) A HARQ process made its first transmission attempt in this TTI:
   2.1) if the HARQ process transmits data successfully (e.g., receives ACK from UTRAN), Data_capacity of the TTI is taken to be equal to min(max_data_per_grant, max_data_per_headroom)/(1+no_of_retx) where:
      2.1.1) max_data_per_grant is the max amount of data that could have been transmitted in the TTI as governed by the serving grant;
      2.1.2) max_data_per_headroom is the max amount of data that could have been transmitted in the TTI as governed by the headroom limit; and
      2.1.3) no_of_retx is the number of retransmissions the HARQ process went through before successfully completing the transmission. (Recall that HARQ processes that are still undergoing re-transmissions will not be considered for the capacity estimation.)
   2.2) If the HARQ process fails to transmit data (e.g., receives NACK or has reached max no. of retransmissions without receiving ACK from the network, e.g., UTRAN), Data_capacity of the TTI is taken to be =0.
3) A HARQ process is carrying out re-transmission in this TTI:
   3.1) if the HARQ process transmits data successfully, Data_capacity of the TTI is taken to be equal to max(data_being_retx,min(max_data_per_grant,max_data_per_headroom))/(1+no_of_retx) where:
      3.1.1) data_being_retx is the amount of data that is being retransmitted in the TTI;
      3.1.2) max_data_per_grant is the max amount of data that could have been transmitted in the TTI as governed by the serving grant in that TTI;
      3.1.3) max_data_per_headroom is the max amount of data that could have been transmitted in the TTI as governed by the headroom limit in that TTI; and
      3.1.4) no_of_retx is the number of retransmissions the HARQ process went through before successfully completing the transmission.
   3.2) if the HARQ process fails to transmit data (e.g., receives NACK or has reached max no. of retransmissions without receiving ACK from the network, e.g., UTRAN), Data_capacity of the TTI is taken to be =0.

The capacity estimate described above can be computed every TTI and filtered, for example using a first order filter, to remove high frequency fluctuations as desired.

Thus, the described apparatus and methods provide for estimating the uplink channel capacity. This estimate can be used by, for example, a traffic generator, such as a video telephony application, to adapt its transmission rate to the channel capacity so as to avoid excessive queuing delays. Along with the estimated channel capacity, the queue size at the transmission component, e.g., a modem, and indication of packet transmission failure from the modem may also be used by the application generating the traffic. Further, the present aspects take into account the following factors: not all TTIs are equally important; the serving grant is used to provide cell-load-limited capacity information; the power headroom is used to provide channel-fading-limited capacity information; and HARQ re-transmissions are tracked to avoid over-estimating capacity. Therefore, according to the present aspects, at a time t, an estimate of the uplink capacity is desired. This quantity is estimated by applying the following formula over the time window (t−Window_length, t), which is an interval of length Window_length in the immediate past:

$$\frac{{\sum }_{Relevant TTIs in T} TTI Data Capacity}{Total Time Occupied by Relevant TTIs}$$

wherein a TTI is considered relevant if there is data awaiting transmission, or being transmitted/retransmitted in that TTI, taking into account one or more TTI relevance exceptions. Thus, the present aspects may lead to a user of a UE implementing these aspects with a better user experience, e.g., by reducing queuing delay or otherwise optimizing data generation based on an estimated channel capacity.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of estimating a channel in a wireless communications environment, comprising:
determining a data capacity associated with a time interval, wherein the data capacity comprises a sum of one or more data capacities of each of at least one relevant transmit time interval (TTI) during the time interval; and
dividing the data capacity associated with the time interval by a total time occupied by the at least one relevant TTI during the time interval to obtain a data channel estimate.

2. The method of claim 1, further comprising determining whether a current TTI is relevant.

3. The method of claim 2, further comprising determining a transmission type of the current TTI where the current TTI is determined to be relevant.

4. The method of claim 3, wherein the transmission type is one of an initial transmission and a retransmission.

5. The method of claim 2, further comprising determining whether data is successfully transmitted during the current TTI where the current TTI is determined to be relevant.

6. The method of claim 2, wherein the current TTI is considered relevant if there is data awaiting transmission or being transmitted or retransmitted in the current TTI, unless a TTI relevance exception exists.

7. The method of claim 6, wherein the TTI relevance exception exists where a transmission buffer associated with a user equipment (UE) is initially empty and a serving grant is zero and an arrival of additional data to a transmission buffer prompts the UE to transmit scheduling information associated with the additional data.

8. The method of claim 6, wherein the TTI relevance exception exists when a HARQ process is currently undergoing retransmission during the current TTI.

9. The method of claim 1, wherein the data capacity depends on at least one of whether the current TTI is relevant, the transmission type of the current TTI, and whether the data was successfully transmitted.

10. The method of claim 1, further comprising adjusting output traffic based upon the data channel estimate.

11. An apparatus for estimating a channel in a wireless communications environment, comprising:
means for determining a data capacity associated with a time interval, wherein the data capacity comprises a sum of one or more data capacities of each of at least one relevant transmit time interval (TTI) during the time interval; and
means for dividing the data capacity associated with the time interval by a total time occupied by the at least one relevant TTI during the time interval to obtain a data channel estimate.

12. The apparatus of claim 11, wherein the current TTI is considered relevant if there is data awaiting transmission or being transmitted or retransmitted in the current TTI, unless a TTI relevance exception exists.

13. The apparatus of claim 11, wherein the data capacity depends on at least one of whether the current TTI is relevant, the transmission type of the current TTI, and whether the data was successfully transmitted.

14. The apparatus of claim 11, further comprising means for adjusting output traffic based upon the data channel estimate.

15. A computer-readable storage medium for estimating a channel in a wireless communications environment, comprising computer-executable instructions for:
determining a data capacity associated with a time interval, wherein the data capacity comprises a sum of one or more data capacities of each of at least one relevant transmit time interval (TTI) during the time interval; and
dividing the data capacity associated with the time interval by a total time occupied by the at least one relevant TTI during the time interval to obtain a data channel estimate.

16. The computer-readable storage medium of claim 14, wherein the current TTI is considered relevant if there is data awaiting transmission or being transmitted or retransmitted in the current TTI, unless a TTI relevance exception exists.

17. The computer-readable storage medium of claim 14, wherein the data capacity depends on at least one of whether the current TTI is relevant, the transmission type of the current TTI, and whether the data was successfully transmitted.

18. The computer-readable storage medium of claim 14, further comprising computer-executable instructions for adjusting output traffic based upon the data channel estimate.

19. An apparatus for estimating a channel in a wireless communications environment, comprising:
a data capacity determining component configured to determine a data capacity associated with a time interval, wherein the data capacity comprises a sum of one or more data capacities of each of at least one relevant transmit time interval (TTI) during the time interval; and
a dividing component configured to divide the data capacity associated with the time interval by a total time occupied by the at least one relevant TTI during the time interval to obtain a data channel estimate.

20. The apparatus of claim 19, further comprising a relevance determining component configured to determine whether a current TTI is relevant.

21. The apparatus of claim 20, further comprising a transmission type determining component configured to determine a transmission type of the current TTI where the current TTI is determined to be relevant.

22. The apparatus of claim 21, wherein the transmission type is one of an initial transmission and a retransmission.

23. The apparatus of claim 20, further comprising a transmission success determining component configured to determine whether data is successfully transmitted during the current TTI where the current TTI is determined to be relevant.

24. The apparatus of claim 20, wherein the current TTI is considered relevant if there is data awaiting transmission or being transmitted or retransmitted in the current TTI, unless a TTI relevance exception exists.

25. The apparatus of claim 24, further comprising a transmission buffer, wherein the TTI relevance exception exists where the transmission buffer associated with a user equipment (UE) is initially empty and a serving grant is zero and an arrival of additional data to the transmission buffer prompts the UE to transmit scheduling information associated with the additional data.

26. The apparatus of claim 24, wherein the TTI relevance exception exists when a HARQ process is currently undergoing retransmission during the current TTI.

27. The apparatus of claim 19, wherein the data capacity depends on at least one of whether the current TTI is relevant, the transmission type of the current TTI, and whether the data was successfully transmitted.

28. The apparatus of claim 19, further comprising an output traffic regulating component configured to adjust output traffic based upon the data channel estimate.
